(19) United States
(12) Patent Application Publication
(10) Pub. No.: US 2015/0370833 A1
(43) Pub. Date: Dec. 24, 2015

(54) VISUAL REFINEMENTS IN IMAGE SEARCH

(71) Applicant: Google Inc., (US)

(72) Inventors: Nicholas G. Fey, Mountain View, CA (US); Edward E. Burns, Cambridge, MA (US)

(73) Assignee: Google Inc., Mountain View, CA (US)

(21) Appl. No.: 13/687,174

(22) Filed: Nov. 28, 2012

Related U.S. Application Data
(60) Provisional application No. 61/564,239, filed on Nov. 28, 2011.

(51) Int. Cl. G06F 17/30

(52) U.S. Cl. CPC G06F 17/30277

(57) ABSTRACT

Methods, systems, and apparatus, including computer programs encoded on a computer storage medium, for presenting visual refinements to an image search. A user device having a user interface submits an initial search query. The user device receives first image search results, each of the first image search results referencing one of a first set of images that are responsive to the initial search query. The user device receives an image query suggestion specifying a refined query and a representative image for the refined query. One or more images from the first set of images is responsive to the refined query, and the representative image is selected from a second set of images that are responsive to the refined query, the second set of images including the one or more images from the first set of images. At least a portion of the first image search results are presented in a results portion of the user interface. The image query suggestion is presented in a suggestion portion of the user interface.

### CROSS-REFERENCE TO RELATED APPLICATION

This application claims priority of U.S. Provisional Application No. 61/564,239, filed Nov. 28, 2011, the entirety of which is hereby incorporated by reference as if fully set forth therein.

### BACKGROUND

This specification relates to data processing and information retrieval.

The Internet provides access to a wide variety of resources such as images, video or audio files, web pages for particular subjects, book articles, or news articles. A search system can identify resources in response to a text query that includes one or more search terms or phrases. The search system ranks the resources based, at least in part, on their relevance to the query and provides search results that respectively reference (e.g., link to) the identified resources. The search results are typically ordered for viewing according to the rank.

To search image resources, a search system can determine the relevance of an image to a text query based on the textual content of the resource in which the image is located and/or based on relevance feedback associated with the image. For example, an information retrieval score measuring the relevance of a text query to the content of a web page on which the image is presented can be one of many factors used to generate an overall search result score for the image.

In some cases, the user's search query may produce a range of image results broad enough to include many pictures that do not satisfy the user's informational need. In some cases, the user may submit further queries representing refinements of the initial search query in order to be served more relevant results.

### SUMMARY

In general, one innovative aspect of the subject matter described in this specification can be embodied in methods that include the actions of submitting, by a user device, an initial search query, the user device having a user interface; receiving, by the user device, first image search results, each of the first image search results referencing one of a first set of images that are responsive to the initial search query; receiving, by the user device, an image query suggestion specifying a refined query and a representative image for the refined query, wherein one or more images from the first set of images is responsive to the refined query, and wherein the representative image is selected from a second set of images that are responsive to the refined query, the second set of images including the one or more images from the first set of images; presenting at least a portion of the first image search results in a results portion of the user interface; and presenting the image query suggestion in a suggestion portion of the user interface. Other embodiments of this aspect include corresponding systems, apparatus, and computer programs, configured to perform the actions of the methods, encoded on computer storage devices.

These and other embodiments can each optionally include one or more of the following features. Methods can further include the actions of determining that a first user interaction with the image query suggestion has occurred; and in response to determining that the first user interaction occurred, presenting a first set of second search results, each second search result referencing an image from the second set of images.

Methods can further include the actions of determining that a second user interaction has occurred; and in response to determining that the second user interaction has occurred, presenting a second different set of the second search results.

The user interface may be a single visual display having a visual layout including the results portion and the suggestion portion, and the first set of second search results may at least partially overlay the results portion of the user interface while maintaining the visual layout.

Methods can further include receiving the initial search query; identifying the first set of images that are responsive to the initial search query; selecting the refined query to which at least a portion of the first images is responsive; selecting the second set of images that are responsive to the refined query, the second set of images being selected from the first set of images; providing, to the user device, the first image search results and the image query suggestion.

Methods can further include, in response to determining that a user interaction with a search submission element presented in the user interface has occurred, submitting, by the user device, the refined query as a search query that requests a set of search results that are responsive to the refined query; receiving, by the user device, second image search results, each of the second image search results referencing an image responsive to the refined query; receiving, by the user device, a second image query suggestion specifying a further refined query and a further representative image for the further refined query, wherein the at least a portion of the images referenced by the second set of search results is also responsive to the further refined query, and wherein the further representative image is selected from the images that are referenced by the second image search results; presenting the second image search results in a results portion of the user interface; and presenting the second image query suggestion in a suggestion portion of the user interface.

Particular embodiments of the subject matter described in this specification can be implemented so as to realize one or more of the following advantages. The presentation of refined search queries and image results can facilitate identification of relevant results without requiring the user to supply all of the key words necessary to retrieve those results. Users can evaluate the results of different defined searches before committing to the new search, for example, by being presented images that are referenced by search results for a current search query and also responsive to a refined search query. Encouraging refined searches reduces the processing resources required to identify images that satisfy the user's informational need by reducing the number of queries that a user enters to receive the identified images.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a search system provides search services.

FIGS. 2A and 2B are screen shots of an example image search results page.

FIG. 3 is a screen shot of another example image search results page.

FIG. 4 is a flow chart of an example process for presenting image query suggestions along with image search results.

FIG. 5 is a flow chart of an example process for serving a user device to present image query suggestions along with image search results.

FIG. 6 is block diagram of an example computer system.

Like reference numbers and designations in the various drawings indicate like elements.

### DETAILED DESCRIPTION

Image search results that are responsive to an initial search query (“initial query”) are presented in a results portion of an image results page. The image results page can also include a suggestion portion in which image query suggestions are presented. An image query suggestion specifies a refined search query (“refined query”) and includes an image representative of the image search results that are responsive to the refined query. In some implementations, the representative image for the refined search query is an image that is referenced by the image search results that are responsive to the initial search query, such that the representative image may provide the user with a “peek ahead” in the image search results for the initial search query.

The user can view additional results of the refined query without leaving the results page for the initial query (e.g., without initiating a request for another web page). For example, interaction with the image query suggestion can cause presentation of a preview window in which a set of image search results that are referenced by the image search results for the initial query, and are also responsive to the refined query.

Further user interaction with the image query suggestion may cause presentation of additional image search results that are referenced by the image search results for the initial search query, and are also responsive to the refined search query. In some implementations, the presentation of the additional image search results can be achieved without submitting the refined query to a search system. For example, the additional image search results may have been previously identified as responsive to the refined search query, and the further user interaction with the image query suggestion may cause presentation of those previously identified image search results. Through these user interactions, the user may be able to scroll among the image search results for the initial query that are also responsive to the refined query prior to submitting the refined query to a search system.

In some implementations, the preview window can include a “search submission” user interface element (“search submission element”) that causes the refined query to be submitted as a search query to a search system in response to user interaction with the search submission element. For example, upon user selection of the image query suggestion, the user device can submit the refined query to the search system as an image search query. That is, a second image results page is requested using the refined query as the search query. The second search results page is then received and presented at the user device. The second search results page can include refinements of the refined query that was submitted, and the refinements may be presented as image query suggestions for the refined query, as described above.

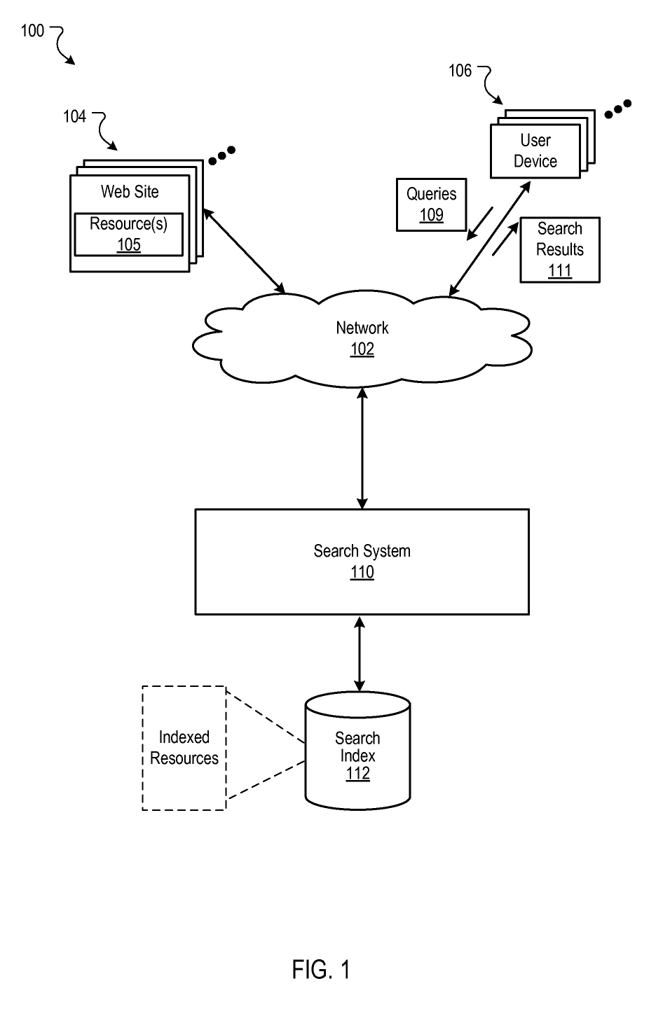

FIG. 1 is a block diagram of an example environment 100 in which a search system 110 provides search services. The example environment 100 includes a network 102, e.g., a local area network (LAN), wide area network (WAN), the Internet, or a combination of them, connects web sites 104, user devices 106, and the search system 110. The environment 100 may include many thousands of web sites 104 and user devices 106.

A web site 104 is one or more resources 105 associated with a domain name and hosted by one or more servers. An example web site is a collection of web pages formatted in hypertext markup language (HTML) that can contain text, images, multimedia content, and programming elements, e.g., scripts. Each web site 104 is maintained by a publisher, e.g., an entity that manages and/or owns the web site.

A resource 105 is data provided by a web site 104 over the network 102 and that is associated with a resource address. Resources 105 include HTML pages, word processing documents, and portable document format (PDF) documents, images, video, and feed sources, to name just a few. The resources 105 can include content, e.g., words, phrases, images and sounds and may include embedded information (e.g., meta information and hyperlinks) and/or embedded instructions (e.g., scripts).

A user device 106 is an electronic device that is under control of a user and is capable of requesting and receiving resources 105 over the network 102. Example user devices 106 include personal computers, mobile communication devices, tablet computing devices, and other devices that can send and receive data over the network 102. A user device 106 typically includes a user application, e.g., a web browser, to facilitate the sending and receiving of data over the network 102.

To facilitate searching of resources 105, the search system 110 identifies the resources 105 by crawling and indexing the resources 105 provided on web sites 104. Data about the resources 105 can be indexed based on the resource to which the data corresponds. The indexed and, optionally, cached copies of the resources 105 are stored in a search index 112.

The user devices 106 submit search queries 109 to the search system 110. In response, the search system 110 accesses the search index 112 to identify resources 105 that are relevant to (e.g., have at least a minimum specified relevance score for) the search query 109. The search system 110 identifies the resources 105, generates search results 111 that identify the resources 105, and returns the search results 111 to the user devices 106. A search result 111 is data generated by the search system 110 that identifies a resource 105 that is responsive to a particular search query, and includes a link to the resource 105. An example search result 111 can include a web page title, a snippet of text or a portion of an image extracted from the web page, and the URL of the web page.

The search results are ranked based, at least in part, on scores related to the resources 105 identified by the search results 111, such as information retrieval (“IR”) scores, and optionally a quality score of each resource relative to other resources. In some implementations, the IR scores are computed from dot products of feature vectors corresponding to a search query 109 and a resource 105, and the ranking of the search results is based on initial relevance scores that are a combination of the IR scores and page quality scores. The search results 111 are ordered according to these initial relevance scores and provided to the user device 106 according to the order.

For image searches, the search system 110 can combine the initial relevance score of a resource with a relevance feedback score of an image embedded in the resource. An example relevance feedback score is a score derived from a selection rate (e.g., click-through-rate or another interaction rate) of an image when that image is referenced in a search result for a query. These combined scores are then used to present search results directed to the images embedded in the resources 105.

The initial relevance scores for an image can be based, in part, on labels that are associated with the image. Labels are textual content or data flags that indicate a topic to which the image belongs. Labels can be explicitly associated with (e.g., indexed according to and/or stored with a reference to) an image, for example, by the publisher that is providing the image. For example, a publisher can associate the text “Eiffel Tower” with an image depicting the Eiffel Tower. Labels can also be explicitly associated with an image by users to whom the image is presented. For example, users can engage in activities, such as online games, in which the users provide text that describes the content of an image that is presented to the user. In turn, when a threshold portion of users have specified particular text as being descriptive of the image, the image can be labeled with the particular text.

Labels can also be associated with an image based on relevance feedback for the image. In some implementations, a label that matches a query can be associated with (e.g., assigned to, indexed according to, and/or stored with a reference to) an image when the image is selected for presentation by users (e.g., who submitted the query) with at least a threshold selection rate (e.g., a threshold click-through-rate or another threshold interaction rate). In turn, the label can then be used to select the image for reference in search results responsive to future instances of the query.

The threshold selection rate may be any appropriate rate, such as 10%, 15%, 20%, or 25%. For example, assume that the threshold selection rate is 10%, and that an image of the Arc de Triomphe has been referenced by search results that were provided in response to the search query “Paris landmarks.” In this example, if the selection rate of the image of the Arc de Triomphe exceeds 10%, the label “Paris landmarks” can be associated with the image of the Arc de Triomphe. The label “Paris landmarks” can also be associated with an image of the Eiffel Tower if the selection rate for the image of the Eiffel Tower also exceeds 10% when presented in response to the search query “Paris landmarks.”

The initial relevance score for an image relative to a particular query can also be based on how well an image label matches the particular query. For example, an image having a label that is the same as the particular query can have a higher relevance score than an image having a label that is a root of the query or otherwise matches the query based on query expansion techniques (e.g., synonym identification or clustering techniques). Similarly, images having labels that match the query are identified as more relevant to the query than images that do not have labels matching the query. In turn, the search result positions at which references to the images having labels that match the query are placed in the image search results page can be higher than the search result positions at which references to the images that do not match the query are placed.

In the example above, the images of the famous Paris café, the Eiffel Tower, and the

Arc de Triomphe are each associated with the label “Paris landmarks,” such that each of these images may be identified as responsive to the query “Paris landmarks.” Thus, references to the images of the famous Paris café, the Arc de Triomphe, and the Eiffel Tower may be referenced by search results 111 that are provided in response to the search query “Paris landmarks.”

The user devices 106 receive the search results 111, e.g., in the form of one or more web pages, and render the search results for presentation to users. In response to the user interacting with (e.g., affirmatively selecting or hovering over) a link in a search result at a user device 106, the user device 106 requests the resource 105 identified by the link. The web site 104 hosting the resource 105 receives the request for the resource from the user device 106 and provides the resource 105 to the requesting user device 106. When the search result references an image, the resource 105 that is requested may be a copy of the image and/or other content that is presented on a same web page with the image.

For brevity, this document refers to user interactions with search results in terms of interactions with a touch screen interface (which may include such actions as tapping, swiping, pinching, spreading, etc.). Other methods of user interaction, such as cursor interaction in conjunction with a mouse or other user input device, will also allow the system to detect and respond to user interaction as described herein.

A user “tap” can be determined to have occurred, for example, when a pointer has been determined to have engaged the touch screen interface at a particular location and disengaged the touch screen within a threshold distance of the particular location (e.g., at the same particular location or within a specified number of pixels from the particular location). When a user tap occurs at a presentation location of an image search result, or an image query suggestion, the image search result or image query suggestion is considered to have been interacted with by the user.

A user “swipe” can be determined to have occurred, for example, when the pointer has been determined to engage the touch screen at a particular location and then disengaged the touch screen outside of the threshold distance of the particular location. For example, when the pointer that has been determined to engage the touch screen at a first location moves across the touch screen more than a threshold distance, and then disengages the touch screen, a user swipe can be determined to have occurred. In response to detecting a user swipe, a user device can “scroll” through an image search results page, or through a set of image search results that are presented in the preview window, as described in more detail below.

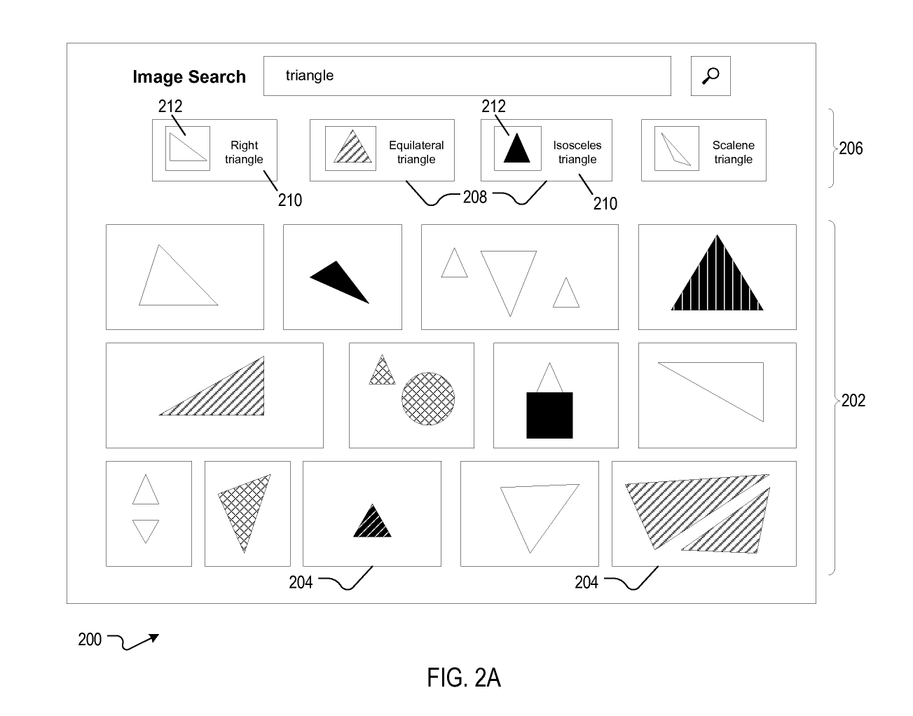

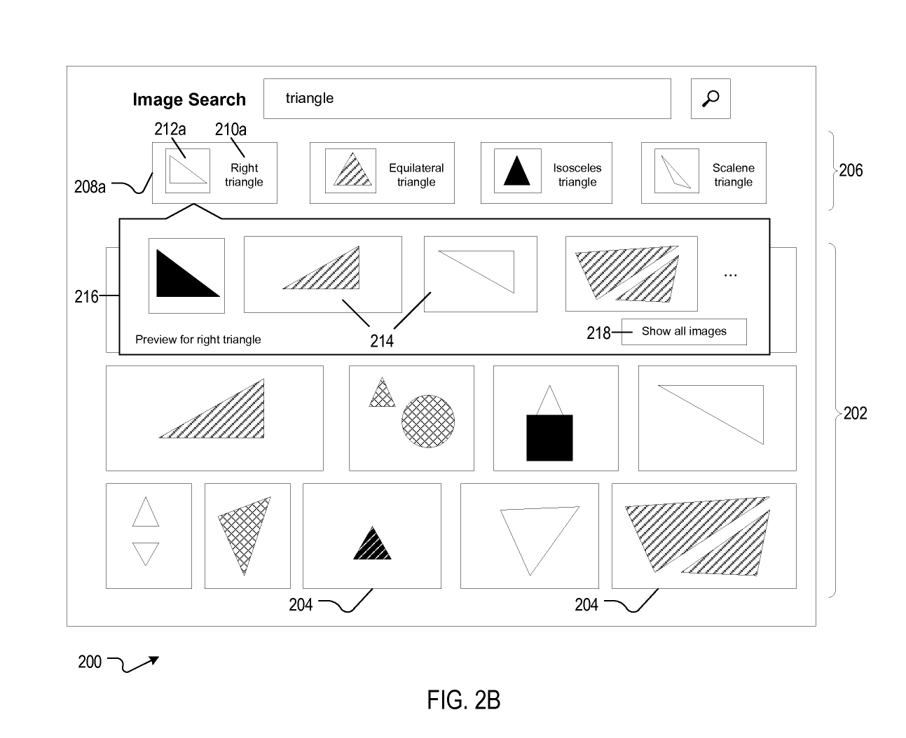

FIG. 2A is an example screen shot of an image search results page 200 presented on a device display. The image search results page 200 as illustrated by FIG. 2 is a search results page that was presented in response to an initial search query that includes the query text “triangle”. The search results page 200 includes a search results section 202 (i.e., a results portion) within which the image results 204 responsive to the initial query are presented. As described above, user interaction with an image result 204 may initiate a request for content such as the image or related web page that the search result 204 references.

In addition to the search results section 202, an image query suggestion section 206 (i.e., a suggestion portion) is also presented on the search results page 200. The image query suggestion section 206 includes a plurality of query suggestions 208. Each query suggestion 208 includes a refined query 210 and a representative image 212. Refined queries 210 for the illustrated example query “triangle” include “right triangle”, “equilateral triangle”, “isosceles triangle”, and “scalene triangle”, as shown in FIG. 2A.

A refined query 210 may be generated by identifying groups of image results responsive to the initial query that are further responsive to a search query having one or more added terms. Query expansion techniques may be used, for example, by the search system to identify these refined queries, including records of previously entered queries by the same and other users. For example, previous search queries having some or all of the terms in the initial query, plus at least one additional term, may be presented as the refined queries. Content related to the image search results, as well as labels for the images as discussed above, may also be used to identify additional terms to use in the refined queries.

In some implementations, the refined queries are search queries that were received from at least a threshold number of users. For example, the refined queries can be queries that were submitted by at least 10% of the users that submitted the initial query prior to submitting the refined query. For example, assume that 100 users submitted the search query “triangle” and that of these 100 users, 30 of them subsequently submitted the search query “right triangle.” In this example, the search query “right triangle” would qualify as a refined query for the search query “triangle”.

The refined queries for a particular search query can also be restricted, for example, based on a number of the images referenced by search results for the particular query that are responsive to the refined query. For example, assume that the query “square triangle” was received by more than 10% of the users that initially submitted the search query “triangle”, but that only one image from the search results for “triangle” was identified as responsive. In this example, if refined queries are restricted to those search queries for which at least 2 images from the image search results for the initial query are also responsive to the refined search query, the query “square triangle” would not be selected as a refined search query for the search query “triangle”.

For each refined query, the subset of the image results for the initial query that are also responsive to the refined query is identified. One of these image results can be selected to be the representative image 212. In some implementations, the representative image 212 may be an image result for the initial query that is not displayed on the initial query results page 200, such that the image 212 is not also associated with a displayed image result 204 in the search results section 202. In some implementations, each representative image 212 is acquired by evaluating each refined query and choosing a result satisfying a relevancy criterion relative to the refined query, such as having a relevance score above a threshold relevance score, or being among a preselected number of the top-ranked image results responsive to the refined query.

In some implementations, the subset of image search results for the initial query that are also responsive to the refined query can be identified asynchronously relative to the presentation of the image search results. For example, when the initial search query is received, the search system can identify the image search results that are responsive to the initial query and provide those image search results and/or the image query suggestions to the user device irrespective of whether the images that are also responsive to the refined queries have been identified. The search system can separately perform a search of the images referenced by the image search results for images that are responsive to the refined query, and asynchronously provide data identifying those image search results for the initial search query that are also responsive to each of the refined queries specified by the image query suggestions.

FIG. 2B is an example screen shot of the image results page 200 following user interaction with an image query suggestion 208a having a refined query 210a and a representative image 210a. In some implementations, the screenshot illustrated by FIG. 2B is presented in response to a user “tap” of the image query suggestion 208a. As shown by FIG.

2B, image results 214 responsive to the refined query 210a are displayed in a preview window 216 in response to the user interaction. The preview window 216 overlays (e.g., occludes) a portion of the search results section 202. In addition to being presented in the preview window 216, some or all of the image results 214 may also be available as one of the image results 204 to the initial query, although one or more of the image results 214 may not be among the image results 204 that are initially presented in the search results section 202 (e.g., prior to a user scrolling down the page). The preview window 216 allows for the presentation of a subset of the image results 214 responsive to the refined query 210 without leaving the results page 200 responsive to the initial query.

In some implementations, in response to an additional user interaction with the preview window 216, additional results responsive to the refined query may be presented in the window 216. For example, in response to detecting a user swipe (e.g., from right to left on the screen) or another action by the user, the device may “scroll” or “page through” the image results 214 to present additional results without leaving the initial query results page 200.

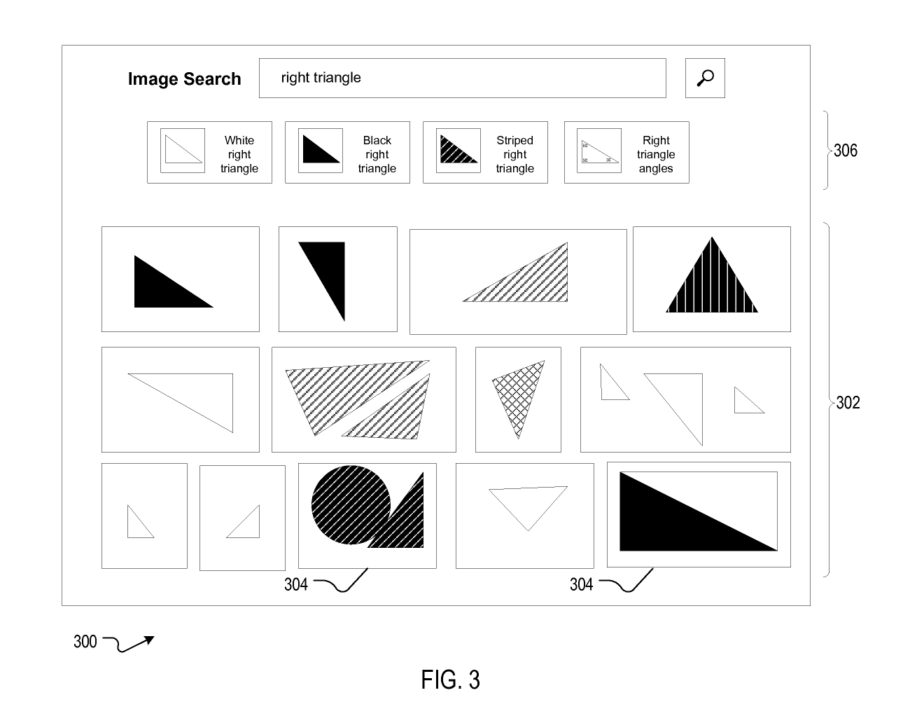

The preview window 216 can include a “search submission” element, such as the “show all images” button 218, with which the user can request presentation of more image search results that are responsive to the refined query. For example, in response to user interaction with the preview window 216, e.g., determining that the user has tapped the “show all images” button 218, the user device initiates a request for content such as a new search results page 300, shown in FIG. 3. The search results page 300 is similar to the results page 200 as described above, but was created using the refined query, “right triangle”, as the search query for which the image results 304 are responsive and displayed in the search results section 302. Using “right triangle” as the new initial query, an image query suggestion section 306 may exist to suggest further refinements to “right triangle” as a query. In some implementations, the search system evaluates whether to provide an image query suggestion section for presentation with an image search results page based on whether or not refined queries are identified. If no refined queries are identified, the image query suggestion section is omitted from display on the image search results page. Certain implementations may choose to omit the image query suggestion if fewer than a threshold number of refined images are identified, such as fewer than three.

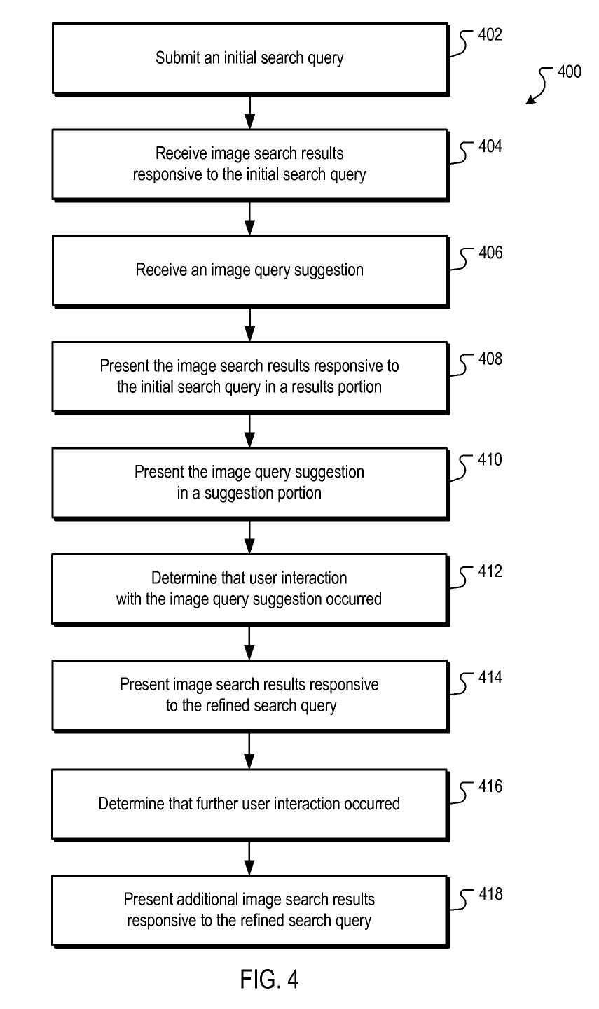

FIG. 4 is a flow chart of an example process 400 for providing image query suggestions to a user. Although the process is illustrated as operations performed by a user device, it will be understood that in some implementations, operations may be performed by other components on the network.

An initial search query is submitted (402). In some implementations, the initial search query is submitted by a user device that includes a user interface. The initial search query may be typed into a search box displayed on the user interface or otherwise entered by the user. User interaction with other elements of the device display, such as links representing search queries, may also cause the device to submit the initial query.

Image results that are responsive to the initial search query are received (404). In some implementations, the image search results each reference (e.g., include a hypertext link to) an image or resource that was identified as being responsive to the initial search query. The image search results can also each include a representative image (e.g., a scaled version of the image, such as a thumbnail) for display on the user device. Some of the image results may also include title text and other information about the image or resource. Data received with the image search results may also include instructions on how or in what order to display the image results.

An image query suggestion is also received (406). In some implementations, the image query suggestion specifies a refined query and a representative image for the refined query. As described above, the refined query can be a query to which at least a portion of the images referenced by the image search results is also responsive. The representative image can be selected, for example, from the portion of the images that are responsive to the initial query and the refined query. For example, an image referenced by the image search results that is determined to have a highest relevance score for the refined query (e.g., among the images referenced by the image search results) can be selected as the representative image.

The image search results responsive to the initial query are presented in a results portion of the user interface (408). The image search results may be presented generally contiguously (e.g., separated by a specified number of pixels), as shown above in the examples associated with FIGS. 2A, 2B, and 3. The presentation may involve displaying the representative image for each image result. In some implementations, the display order may be at least partially determined by a ranking such as by relevance score.

In some implementations, each image search result includes a link such that, upon user interaction with the image search result, the device submits a request for a linked image or a resource that is located at the resource address specified by the link. In other implementations, interaction with the image search result causes presentation of additional information about the image search result, such as a size of the image, a location of the resource from which the image was selected, or other information about the image (e.g., a publisher of the image).

The image query suggestion is presented in a suggestion portion of the user interface (410). The suggestion portion may be near to but visually separate from the results portion, such that a visual layout on a single visual display includes both the results portion and the suggestion portion. Multiple image query suggestions may be presented within the suggestion portion, as described above with reference to FIG. 2A. Each image query suggestion may be displayed with both a representative image and text specifying a refined query. In some implementations, the appearance of the image query suggestion is different from the appearance of the image search results in order to clearly distinguish between them. For example, the representative image for the image query suggestion may have smaller dimensions than the image search results that are presented in the results portion.

User interaction with the image query suggestion is determined to have occurred (412). The user interaction may represent a tap or other selection of the visual representation of the image query suggestion on the display.

In response to the user interaction, image search results for the initial search query that are also responsive to the refined search query are presented (414). These results may be presented in a preview window that overlays part of the results portion of the user interface, such that the visual layout is maintained while presenting image search results in the preview window. The image search results that are presented in the preview window may generally be presented in a manner similar to that by which the image search results are presented in the results portion of the display. For example, a representative image for each of the image search results that are responsive to the refined query can be presented in the preview window.

Further user interaction is determined to have occurred (416). In some implementations, this further user interaction may be, for example, user interaction with the suggestion portion of the user interface. The further user interaction can be, for example, a user swipe across the suggestion portion of the user interface.

In response to determining that the further user interaction has occurred, the device presents additional image search results responsive to the refined query (418). In some implementations, the presentation of the additional search results can be implemented in a manner that causes the additional images to be presented as visually “scrolling” through the suggestion portion. For example, the additional image search results can “scroll” into the suggestion portion as at least some of the originally presented results “scroll” out of the suggestion portion (i.e., are no longer presented in the suggestion portion).

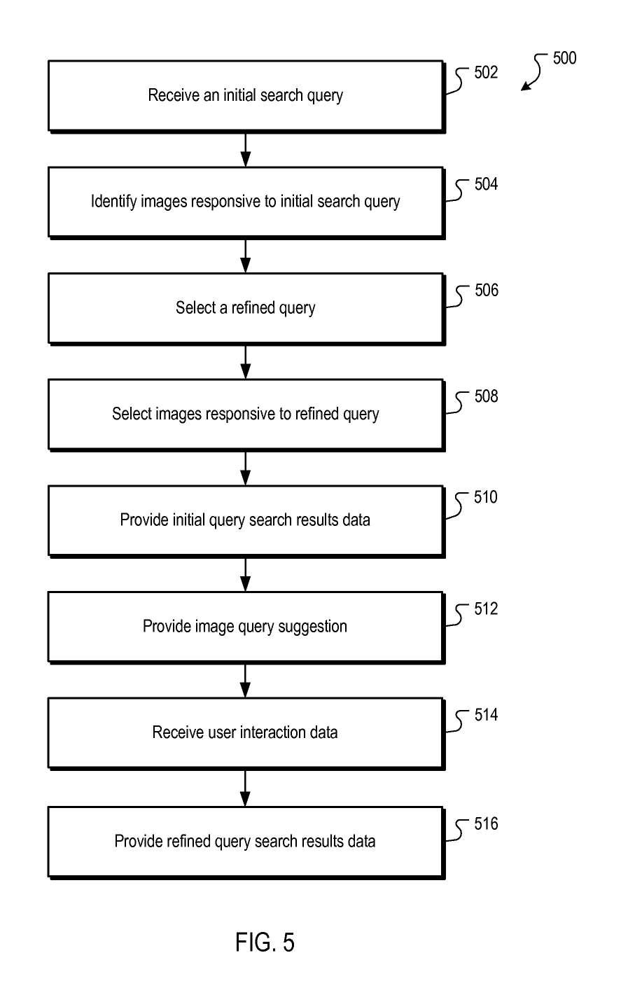

FIG. 5 is a flow chart of an example process 500 for serving image query suggestions to a user device for presentation to a user. Although the process is illustrated as a series of method steps performed by a server in communication with a user device, it will be understood that in some implementations, certain steps may be performed by other components on the network.

An initial search query is received (502). The initial search query may be directly entered by the user, or may be generated by intermediate processes or third parties. The initial search query may be part of a URL entered by the user, may have been a suggestion given in conjunction with a previous search result, or may be a link presented to the user for interaction. However received, the initial query may go through processing such as canonization, and the query text may be supplemented or replaced to improve the accuracy and breadth of the results.

Images responsive to the initial query are identified (504). Identifying responsive images may involve submitting the initial query, either as originally entered or as processed, to an image search system capable of evaluating the query and returning images. The images may be part of a database and may be periodically indexed. Methods for returning relevant image results in response to a query are further described above with respect to FIG. 1.

A refined query is selected (506). Selecting a refined query may involve searching records to determine what related queries have been previously entered, as well as comparing the results of the previous queries to the results of the initial query. Servers employing query expansion methods may be used to aid in locating and evaluating potential query refinements.

Images responsive to the refined query are selected (508). These images may be selected from the images identified as responsive to the initial query. As with identifying the images responsive to the initial query, as described above, selecting images responsive to the refined query may involve submitting the refined query or a processed version of the refined query to an image search system.

In some implementations, only a limited number of images responsive to the refined query are selected at this point in the process 500. Because several image query suggestions may be included in each page, and because the primary interaction with most image query suggestions may be viewing a small number of preview images as shown with respect to FIG. 3 above, selecting at most a preselected number of images, for example selecting fewer than twenty images, may be acceptable. In some implementations, upon user interaction with a given image query suggestion, additional responsive images may be identified in order to prepare for the much greater likelihood that the user device will present them.

Initial query search results data is provided (510) in order to cause the user device to display the image results. Providing the data may involve providing reduced and processed image files representative of the search results, or simply providing data identifying the image resources such that the user device can retrieve the image data from another part of the system. Each search result may include a link to the image or associated resource that the result represents.

Image query suggestion data is also provided (512) in order to cause the user device to display an image query suggestion, which includes both the refined query and an image from the images selected as responsive to the refined query. The image query suggestion may be displayed on the same page as the image results.

User interaction data is received (514), indicating the user has interacted with the query suggestion, such as by tapping it. In response, data is provided to cause the device to display at least some image results associated with the images selected as responsive to the refined query (516), allowing the user to preview those image results. In some implementations, the image results for images responsive to the refined query may be displayed without displacing other image results, such as by overlaying part of the image search results. Further user interaction with the image query suggestion or the image results responsive to the refined query may cause the presentation of further image results responsive to the refined query, or may cause the system to begin the process again using the refined query as a newly entered initial query, as described with respect to FIG. 3 above.

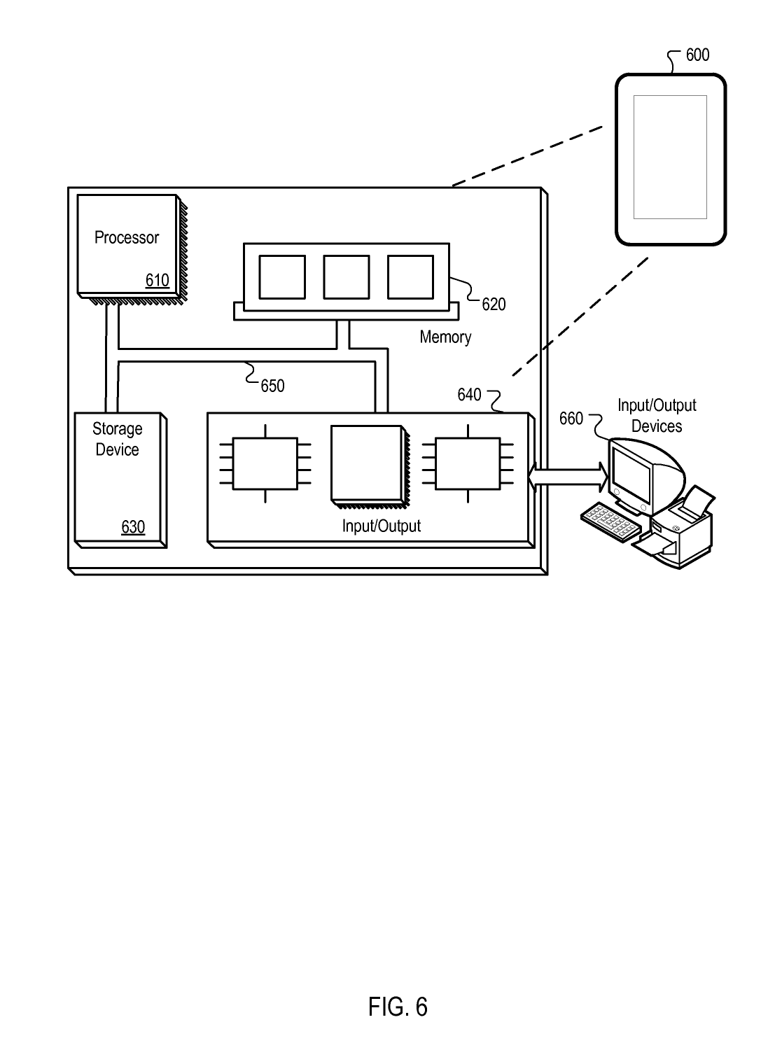

FIG. 6 is block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include a touch screen interface to receive input data and display data to the user, e.g., a tablet computer or mobile communications device. Other implementations, however, can also be used, such as a keyboard, printer, and display devices 660, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
submitting, by a user device, an initial search query, the user device having a user interface, wherein the user interface is a single visual display having a visual layout including a results portion and a suggestion portion;
receiving, by the user device and in response to submission of the initial search query, first image search results, each of the first image search results referencing one of a first set of images that are responsive to the initial search query;
receiving, by the user device, a query suggestion specifying a refined textual query that differs from the initial search query and a representative image for the refined textual query, wherein the representative image for the refined query is included in the first image search results;
presenting, on a display of the user device, at least a portion of the first image search results in the results portion of the user interface;
presenting, on the display of the user device, the query suggestion in the suggestion portion of the user interface while the portion of the first image results are presented;
determining that a first user interaction with the query suggestion has occurred; and
in response to determining that the first user interaction with the query suggestion occurred, presenting, on the display of the user device, a subset of search results, from the first image search results received in response to submission of the initial search query, that are also responsive to the refined textual query, including:
presenting, on the display of the user device, the subset of search results from the first image search results in a preview pane that at least partially overlays the results portion of the user interface while maintaining the visual layout of the results portion of the user interface.

2. (canceled)

3. The method of claim 1, further comprising:
determining that a second user interaction has occurred; and
in response to determining that the second user interaction has occurred, presenting a second different set of image search results.

4. (canceled)

5. The method of claim 1, further comprising:
receiving the initial search query;
identifying the first set of images that are responsive to the initial search query;
selecting the refined query to which at least a portion of the first images is responsive;
selecting a second set of images that are responsive to the refined query, the second set of images being selected from the first set of images; and
providing, to the user device, the first image search results and the query suggestion.

6. The method of claim 1, further comprising, in response to determining that a user interaction with a search submission element presented in the user interface has occurred:
submitting, by the user device, the refined query as a search query that requests a set of search results that are responsive to the refined query;
receiving, by the user device, second image search results, each of the second image search results referencing an image responsive to the refined query;
receiving, by the user device, a second image query suggestion specifying a further refined query and a further representative image for the further refined query, wherein the at least a portion of the images referenced by the second image search results is also responsive to the further refined query, and wherein the further representative image is selected from the images that are referenced by the second image search results;
presenting the second image search results in a results portion of the user interface; and
presenting the second image query suggestion in a suggestion portion of the user interface.

7. A non-transitory computer storage medium encoded with a computer program, the program comprising instructions that when executed by one or more data processing apparatus cause the one or more data processing apparatus to perform operations comprising:
submitting, by a user device, an initial search query;
receiving, in response to submission of the initial search query, first image search results, each of the first image search results referencing one of a first set of images that are responsive to the initial search query;
receiving a query suggestion specifying a refined textual query that differs from the initial search query and a representative image for the refined textual query, wherein the representative image for the refined query is included in the first image search results;
presenting, on a display of the user device, at least a portion of the first image search results in a results portion of a user interface having a single visual layout including the results portion and a suggestion portion;
presenting, on the display of the user device, the query suggestion in the suggestion portion of the user interface while the portion of the first image results are presented;
determining that a first user interaction with the query suggestion has occurred; and
in response to determining that the first user interaction with the query suggestion occurred, presenting, on the display of the user device, a subset of search results, from the first image search results received in response to submission of the initial search query, that are also responsive to the refined textual query, including:
presenting, on the display of the user device, the subset of search results from the first image search results in a preview pane that at least partially overlays the results portion of the user interface while maintaining the visual layout of the results portion of the user interface.

8. (canceled)

9. The computer storage medium of claim 7, wherein the program includes instructions that when executed by the data processing apparatus cause the data processing apparatus to perform operations further comprising:
determining that a second user interaction has occurred; and
in response to determining that the second user interaction has occurred, presenting a second different set of image search results.

10-11. (canceled)

12. The computer storage medium of claim 7, wherein the program includes instructions that when executed by the data processing apparatus cause the data processing apparatus to perform operations further comprising, in response to determining that a user interaction with a search submission element presented in the user interface has occurred:
submitting the refined query as a search query that requests a set of search results that are responsive to the refined query;
receiving second image search results, each of the second image search results referencing an image responsive to the refined query;
receiving a second image query suggestion specifying a further refined query and a further representative image for the further refined query, wherein the at least a portion of the images referenced by the second search results is also responsive to the further refined query, and wherein the further representative image is selected from the images that are referenced by the second image search results;
presenting the second image search results in a results portion of the user interface; and
presenting the second image query suggestion in a suggestion portion of the user interface.

13. A system comprising:
a user device having a user interface, wherein the user interface is a single visual display having a visual layout including a results portion and a suggestion portion, and
one or more processors configured to perform operations comprising:
submitting an initial search query;
receiving, in response to submission of the initial search query, first image search results, each of the first image search results referencing one of a first set of images that are responsive to the initial search query;
receiving a query suggestion specifying a refined textual query that differs from the initial search query and a representative image for the refined textual query, wherein the representative image for the refined query is included in the first image search results;
presenting, on a display of the user device, at least a portion of the first image search results in a results portion of a user interface having a single visual layout including the results portion and a suggestion portion;
presenting, on the display of the user device, the query suggestion in the suggestion portion of the user interface while the portion of the first image results are presented;
determining that a first user interaction with the query suggestion has occurred; and
in response to determining that the first user interaction with the query suggestion occurred, presenting, on the display of the user device, a subset of search results, from the first image search results received in response to submission of the initial search query, that are also responsive to the refined textual query, including:
presenting, on the display of the user device, the subset of search results from the first image search results in a preview pane that at least partially overlays the results portion of the user interface while maintaining the visual layout of the results portion of the user interface.

14. (canceled)

15. The system of claim 13, wherein the one or more processors are configured to perform operations further comprising:
determining that a second user interaction has occurred; and
in response to determining that the second user interaction has occurred, presenting a second different set of image search results.

16. (canceled)

17. The system of claim 13, wherein the one or more processors are configured to perform operations further comprising:
receiving the initial search query;
identifying the first set of images that are responsive to the initial search query;
selecting the refined query to which at least a portion of the first images is responsive;
selecting a second set of images that are responsive to the refined query, the second set of images being selected from the first set of images; and
providing, to the user device, the first image search results and the query suggestion.

18. The system of claim 13, wherein the one or more processors are configured to perform operations further comprising, in response to determining that a user interaction with a search submission element presented in the user interface has occurred:
submitting the refined query as a search query that requests a set of search results that are responsive to the refined query;
receiving second image search results, each of the second image search results referencing an image responsive to the refined query;
receiving a second image query suggestion specifying a further refined query and a further representative image for the further refined query, wherein the at least a portion of the images referenced by the second search results is also responsive to the further refined query, and wherein the further representative image is selected from the images that are referenced by the second image search results;
presenting the second image search results in a results portion of the user interface; and
presenting the second image query suggestion in a suggestion portion of the user interface.

19. The method of claim 1, wherein presenting the subset of search results that are also responsive to the refined textual query comprises selecting the subset of search results from the first image search results without transmitting the refined textual query to a remote search system.
